(19) United States
(12) Patent Application Publication
(10) Pub. No.: US 2019/0198234 A1
(43) Pub. Date: Jun. 27, 2019

(54) INDUCTOR

(71) Applicant: SAMSUNG ELECTRO-MECHANICS CO., LTD., Suwon-Si (KR)

(72) Inventors: Ji Hyung JUNG, Suwon-Si (KR); Boum Seock KIM, Suwon-Si (KR); Kang Wook BONG, Suwon-Si (KR)

(21) Appl. No.: 16/101,903

(22) Filed: Aug. 13, 2018

(30) Foreign Application Priority Data
Dec. 27, 2017 (KR) 10-2017-0180629

(51) Int. Cl. H01F 27/32; H01F 27/28; H01F 27/245; H01F 41/04; H01F 41/12

(52) U.S. Cl. CPC H01F 27/323; H01F 27/2804; H01F 2027/2809; H01F 41/041; H01F 41/122; H01F 27/245

(57) ABSTRACT

An inductor includes a body including a coil having a support member having a through hole and disposed on at least one surface of the support member, and a magnetic material encapsulating the support member and the coil, and filling the through hole, and external electrodes disposed on external surfaces of the body. The coil includes a plurality of coil patterns and an insulating layer disposed on surfaces of the plurality of coil patterns to insulate the plurality of adjacent coil patterns from each other, and the insulating layer includes a ceramic material.

### CROSS-REFERENCE TO RELATED APPLICATION

This application claims the benefit of priority to Korean Patent Application No. 10-2017-0180629, filed on Dec. 27, 2017 in the Korean Intellectual Property Office, the disclosure of which is incorporated herein by reference in its entirety.

### BACKGROUND

### 1. Field

The present disclosure relates to an inductor, and more particularly, to a power inductor.

### 2. Description of Related Art

Recently, high-performance, lightweight, small-sized components are required due to the development of portable wireless communications devices and wearable device power generation. In particular, high frequencies are increasingly used, and it is required to stably supply power in a used frequency region. Thus, due to having a function of suppressing a sudden change in current at a power source terminal, power inductors that can be used at high frequencies and at high currents, in accordance with the development of smartphones and wearable devices, are required. In order to maintain highly reliable component characteristics in harsh user environments, power inductors require a highly reliable product design but related art inductor components have a high possibility of short circuits occurring, due to a degradation of dielectric strength in spite of coating between coil patterns.

### SUMMARY

An aspect of the present disclosure may provide an inductor capable of maintaining high reliability even in a harsh user environment.

According to an aspect of the present disclosure, an inductor may include: a body including a support member having a through hole, a coil disposed on at least one surface of the support member, having a plurality of coil patterns; and a magnetic material encapsulating the support member and the coil, and filling the through hole; and external electrodes disposed on external surfaces of the body. The coil includes a plurality of coil patterns and an insulating layer disposed on surfaces of the plurality of coil patterns to insulate the plurality of adjacent coil patterns from each other, and the insulating layer includes a ceramic material.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view of an inductor according to an exemplary embodiment in the present disclosure;

FIG. 2 is a cross-sectional view taken along line I-I′ of FIG. 1; and

FIG. 3 is a cross-sectional view of an inductor according to a modification of the inductor illustrated in FIGS. 1 and 2.

### DETAILED DESCRIPTION

Exemplary embodiments of the present disclosure will now be described in detail with reference to the accompanying drawings.

Hereinafter, an inductor according to an exemplary embodiment in the present disclosure will be described, but it is not limited thereto.

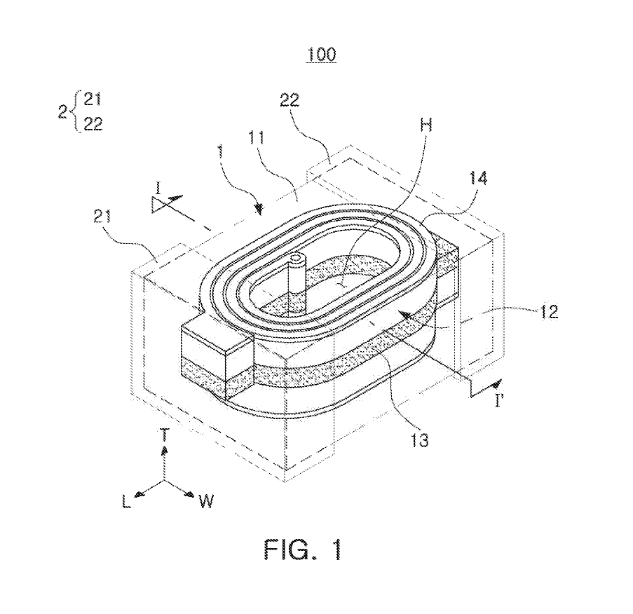

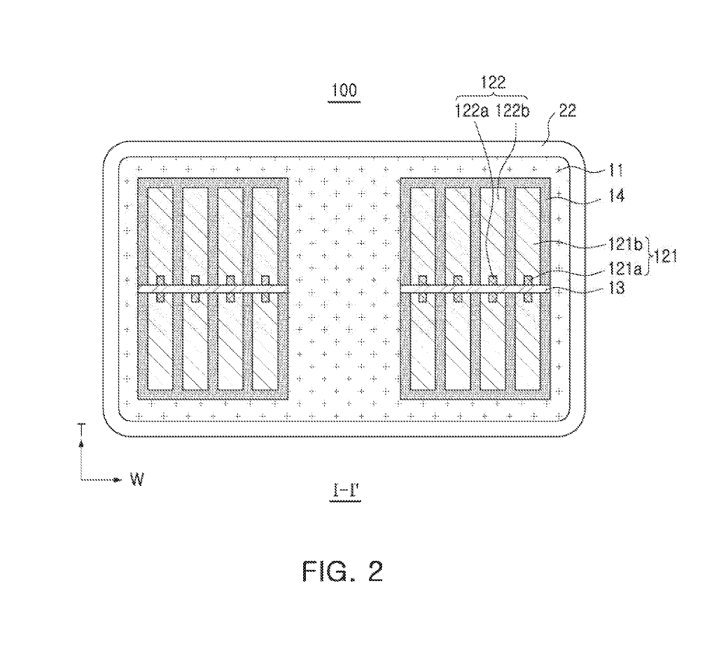

FIG. 1 is a perspective view of an inductor according to an exemplary embodiment in the present disclosure, and FIG. 2 is a cross-sectional view taken along line I-I′ of FIG. 1.

Referring to FIGS. 1 and 2, an inductor 100 of the present disclosure includes a body 1 and external electrodes 2 disposed on external surfaces of the body 1.

The external electrodes 2 may include first and second external electrodes 21 and 22 spaced apart from each other on the external surfaces of the body 1, and the first and second external electrodes 21 and 22 may have opposite polarities.

The body 1 may have an upper surface and a lower surface opposing each other in the thickness direction T, a first end surface and a second end surface opposing each other in the length direction L, and a first side surface and a second side surface opposing each other in the width direction W, and have a substantially hexagonal shape.

It is illustrated that the first and second external electrodes 21 and 22 extend from the first and second end surfaces of the body 1 to portions of the upper surface, portions of the lower surface, and portions of the first and second side surfaces, but, without being limited thereto, the first and second external electrodes 21 and 22 may be modified to have an alphabet L shape or to be arranged only on the lower surface of the body 1.

The body 1 may include a magnetic material 11 having magnetic properties. The magnetic material of the body 1 may be formed by providing ferrite or metal magnetic particles in a resin. The metal magnetic particles may include at least one selected from the group consisting of iron (Fe), silicon (Si), chrome (Cr), aluminum (Al), and nickel (Ni). The magnetic material encapsulates a coil inside the body 1, and in this case, at least one magnetic sheet may be stacked or a molding scheme may be used. When the magnetic material is formed by utilizing a scheme of stacking a plurality of magnetic sheets, the plurality of magnetic sheets may be integrated without visible boundaries therebetween. In particular, when the scheme of stacking a plurality of magnetic sheets is utilized to form the magnetic material, an insulating layer formed on a surface of the encapsulated coil may be damaged by a force of compressing for lamination. However, the inductor of the present disclosure eliminates the possibility of damage to the insulating layer of the coil 12 by strengthening dielectric strength of the insulating layer.

The body 1 includes a coil 12 and a support member 13 provided in the magnetic material 11.

The coil 12 includes a plurality of coil patterns 121 and 122. According to schemes to form a plurality of coil patterns, inductors are classified as a multilayer inductor in which coil patterns are formed on a magnetic sheet and connected to each other through vias, a wound type inductor in which a coil is wound by utilizing a bobbin, or the like, and a thin film type inductor in which coil patterns are formed by applying plating to at least one of one surface and the other surface of a substrate. The inductor 100 of the present disclosure, including a support member and adopting the scheme of forming coil patterns on at least one of upper and lower surfaces of the support member, is a thin film type inductor. The thin film inductor is advantageous in forming a high-capacity inductor, which may be realized by increasing the number of turns and an aspect ratio of coil patterns. A cross-section of the coil patterns 121 and 122 may have a rectangular shape extending substantially in the thickness direction, and if necessary, an upper surface of the cross-section of the coil patterns may be modified to be convex or concave. In order to form the coil patterns 121 and 122, plating is used, and, to this end, seed layers 121a and 122a having a predetermined pattern for formation of a coil pattern on the support member are included. There is no limitation in forming the seed layers 121a and 122a. That is, a scheme of forming a thin film plating layer and subsequently patterning the thin film plating layer through exposure and development utilizing a dry film or a sputtering scheme may be used. Either scheme may be appropriately selected by a person skilled in the art according to manufacturing environments and conditions. Plating layers 121b and 122b for substantially determining an aspect ratio of the coil patterns may be disposed on the seed layers 121a and 121b, respectively, and the plating layers 121b and 122b may be formed by performing plating a plurality of times. Here, if a desired thickness may be realized by performing plating once, plating may be performed only once. However, in the case of forming coil patterns having a high aspect ratio through single plating, the coil patterns may be grown in the thickness direction, leading to a problem that the coil patterns may not be uniformly grown in the width direction, as well as in the thickness direction. In particular, as the coil patterns are excessively grown, rather than uniformly grown, in the width direction, a short-circuit may occur between the coil patterns adjacent to each other. In order to prevent this, for example, an insulating pattern having openings having a shape corresponding to the coil patterns may be formed on the support member and plating is applied only to the inside of the openings. Through this method, a short circuit that may occur due to undesired overplating of coil patterns may be prevented in advance. The insulating pattern having openings is removed after the coil patterns are completely formed, and thus, a final inductor does not have the insulating pattern.

The coil 12 including the coil patterns 121 and 122 adjacent to each other is supported by the support member 13. The support member 13 serves to assist formation of the coil 12 and to support the coil 12 by appropriate strength after completion of the coil 12. The support member 13 includes a through hole H at the center thereof. As the through hole H is filled with the magnetic material, magnetic flux generated by the coil 12 may be strengthened. The support member 13 may further include a via hole near the through hole H, in addition to the through hole H. The via hole serves to form a via allowing an upper coil formed on one surface of the support member 13 and a lower coil formed on the other surface of the support member 13 to be electrically connected therethrough when the coil is disposed on both one surface and the other surface of the support member 13. The upper and lower coils are substantially symmetrical in relation to the support member 13. The via hole is filled with a conductive material and a specific shape thereof may be appropriately selected by a person skilled in the art.

The supporting member 13 including the through hole H may be formed as a thin plate. A material of the supporting member 13 is not limited and may be a thermosetting resin such as an epoxy resin, a thermoplastic resin such as polyimide, and a resin impregnated with a reinforcing material such as a glass fiber or an inorganic filler may be used. Specifically, the support member 13 may be a PID resin, a bismaleimide triazine (BT) resin, Ajinomoto build-up film (ABF), FR-4, or the like, but is not limited thereto. A specific thickness of the support member is not limited as long as it can appropriately support the coil 12 and may be within a range from 20 μm to 60 μm, for example.

The coil patterns 121 and 122 are supported on the support member 13 and a space between the coil patterns 121 and 122 is insulated by an insulating layer 14. The insulating layer 14 is a ceramic insulating coating. The insulating layer 14 is formed by coating surfaces of the coil patterns 121 and 122 with a ceramic material such as silica, alumina, or the like, to enhance insulation properties, in particular, dielectric strength. This results in enhanced reliability of the inductor through insulation enhancement.

A scheme of forming the insulating layer 14 is not limited. For example, sputtering, chemical vapor deposition (CVD), atomic layer deposition (ALD), or the like, may be adopted and may be appropriately selected in consideration of characteristics required by a person skilled in the art and a manufacturing environment.

Since the insulating layer 14 includes a ceramic material, insulation reliability is superior to the case of coating a resin on the surface of the coil pattern. In particular, when a scheme of compressing a magnetic sheet to encapsulate the insulatedly coated coil with a magnetic material is used, the resin covering the coil is often damaged by an external force applied thereto. However, in the case of covering the coil with a ceramic material having excellent dielectric strength, the ceramic material may be rarely damaged in spite of an external force. As a result, a possibility of generating a short-circuit between coil patterns due to weakening of dielectric strength during a process of manufacturing the inductor or during user operation may be significantly reduced.

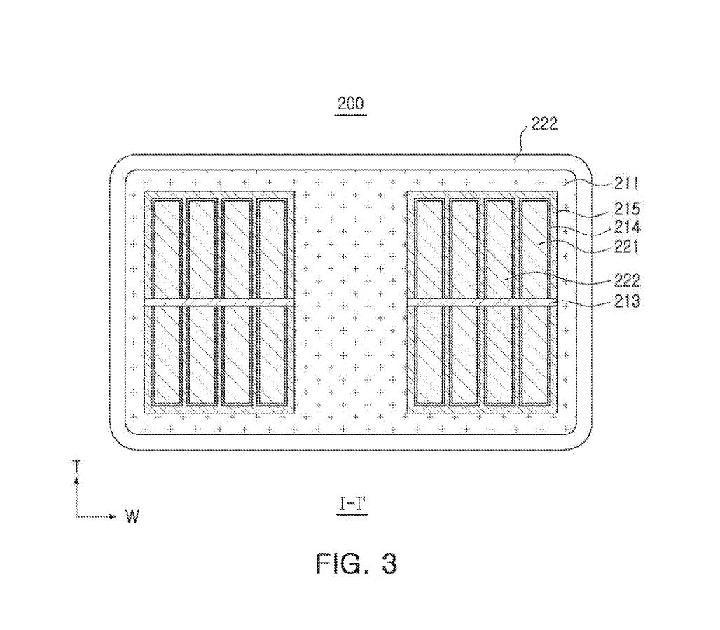

FIG. 3 is a cross-sectional view of an inductor 200 according to a modification of the inductor of FIGS. 1 and 2. The inductor 200 includes the substantially same components as those of the inductor 100 described above with reference to FIGS. 1 and 2, except for a structure of an insulating layer 214, and thus, descriptions of the same components will be omitted for the purposes of description.

The inductor 200 is similar to the inductor 100 described above in that the inductor 200 is formed by directly arranging an insulating layer 214 formed of a ceramic material on surfaces of a plurality of coil patterns 221 and 222 to increase dielectric strength of the coil, but the inductor 200 further includes an insulating film 215 on the insulating layer 214. Unlike the insulating layer 214 formed of a ceramic material, the insulating film 215 is formed of an organic material and, specifically, includes a parylene resin. In some cases, parylene is directly applied to a coil surface and used as a single insulating layer, but, in the inductor 200 of the present disclosure, parylene is not directly applied to a surface of the coil patterns, and the insulating layer formed of a ceramic material is first formed on the surfaces of the coil patterns and the insulating film including a parylene resin is secondly formed on the insulating layer. In this case, dielectric strength may be further strengthened, and the dual insulating structure strengthens dielectric strength and reliability even when an operating environment of the user is subject to harsh conditions such as high temperatures and high humidity.

There is no limitation in a method for forming the insulating film and any method may be used as long as it can form an organic material on the insulating layer formed of a ceramic material. For example, a CVD method may be utilized and, in this case, the insulating film may extend to an inner surface of a through hole in the support member.

As described above, the inductor, as a thin film type inductor in which the coil patterns are grown by utilizing the support member, including the insulating layer formed directly on the surfaces of the coil patterns to insulate the coil patterns adjacent to each other and including a ceramic material to enhance dielectric strength is provided.

As set forth above, according to exemplary embodiments of the present disclosure, the possibility of a defect due to a short circuit between coil patterns may be reduced by strengthening insulating properties between the plurality of coil patterns inside the coil of the inductor. In addition, in the inductor, since the insulating properties of the insulating layer disposed on the coil patterns are strengthened, when the magnetic material (i.e., magnetic particles) included in the body is compressed on the coil patterns, occurrence of dielectric breakdown of the insulating layer and a short-circuit defect between the magnetic material and the coil patterns due to mechanical stress based on the magnetic material may be effectively prevented.

While exemplary embodiments have been shown and described above, it will be apparent to those skilled in the art that modifications and variations could be made without departing from the scope of the present disclosure as defined by the appended claims.

What is claimed is:

1. An inductor comprising:
a body including a support member having a through hole, a coil disposed on at least one surface of the support member, and having a plurality of coil patterns, and a magnetic material encapsulating the support member and the coil, and filling the through hole;
an insulating layer disposed on surfaces of the plurality of coil patterns and insulating adjacent coil patterns of the plurality of coil patterns; and
external electrodes disposed on external surfaces of the body,
wherein the insulating layer includes a ceramic material.

2. The inductor of claim 1, wherein
the ceramic material includes alumina.

3. The inductor of claim 1, wherein
the ceramic material includes silica.

4. The inductor of claim 1, wherein
each of the plurality of coil patterns includes a seed layer and a plating layer formed on the seed layer.

5. The inductor of claim 1, wherein
the support member includes a via hole spaced apart from the through hole, and the via hole is filled with a conductive material.

6. The inductor of claim 1, wherein
an insulating film is further disposed on the insulating layer.

7. The inductor of claim 6, wherein
the insulating film includes a parylene resin.

8. The inductor of claim 6, wherein
a dual insulating structure including an insulating layer and an insulating film is disposed on an inner side surface of an innermost coil pattern and an outer side surface of an outermost coil pattern among the plurality of coil patterns.

9. The inductor of claim 1, wherein
the magnetic material has a structure in which at least one magnetic sheet is stacked.

10. The inductor of claim 9, wherein
the at least one magnetic sheet is provided in plural, and the plurality of magnetic sheets are integrated without visible boundaries therebetween.

11. The inductor of claim 1, wherein
the insulating layer is in direct contact with the support member.

12. The inductor of claim 6, wherein
the insulating layer and the insulating film are each in direct contact with the support member.
